(19) United States
(12) Patent Application Publication
(10) Pub. No.: US 2015/0186013 A1
(43) Pub. Date: Jul. 2, 2015

(54) ELECTRONIC DEVICE AND KEY INPUT PROMPT METHOD

(71) Applicants: BOE TECHNOLOGY GROUP CO., LTD., BEIJING (CN); CHENGDU BOE OPTOELECTRONICS TECHNOLOGY CO., LTD., SICHUAN (CN)

(72) Inventors: Kun Li, BEIJING (CN); Feng Bai, Beijing (CN); Youngyik Ko, Beijing (CN); Zhiqin Zhang, Beijing (CN)

(73) Assignee: BOE TECHNOLOGY GROUP CO., LTD., BEIJING (CN)

(21) Appl. No.: 14/416,258

(22) PCT Filed: Apr. 14, 2014
(86) PCT No.: PCT/CN2014/075260

§ 371 Date: Jan. 21, 2015

(30) Foreign Application Priority Data
Dec. 26, 2013 (CN) 201310739630.6

(51) Int. Cl. G06F 3/0484; G06F 3/0488

(52) U.S. Cl. CPC G06F 3/04842; G06F 3/0488

(57) ABSTRACT

The present invention provides an electronic device and a key input prompt method. The electronic device includes: a touch panel; multiple transparent deformation units arranged above the touch panel, each deformation unit corresponding to an area on the touch panel and having an initial shape; a first detection unit detecting whether a virtual keyboard is displayed on the touch panel and acquiring a first determination result; a first specifying unit selecting at least one target character from multiple characters included in the virtual keyboard and specifying a display area of the target character when the first detection result indicates that the virtual keyboard is displayed on the touch panel, a second specifying unit specifying a target deformation unit that corresponds to the display area from the deformation units, and a generation unit generating an excitation source for exciting the target deformation unit, the target deformation unit deforms from the initial shape to a target shape under the control of the excitation source. The electronic device according to the present invention can provide an actual tactile sensation to a user.

### CROSS-REFERENCE TO RELATED APPLICATION

This application is the U.S. national phase of PCT Application No. PCT/CN2014/075260 filed on Apr. 14, 2014, which claims priority to Chinese Patent Application No. 201310739630.6 filed on Dec. 26, 2013, the disclosures of which are incorporated in their entirety by reference herein.

### TECHNICAL FIELD

The present disclosure relates to the field of electronic input-output technology, in particular to an electronic device providing a tactile sensation and a key input prompt method.

### BACKGROUND

Currently, display panels having touch sensation functions are widely used in various network terminals, particularly, used in mobile communication terminals. With the development of technology, users of the terminals require mobile communication terminal can provide a better human-machine interface, and the operation method of the device meets ergonomic requirement. When the user performs key input using an actual keyboard (that is, typing operation), the positioning of the fingers usually includes visual positioning and tactile positioning. A user who has got used to typing mainly relies on tactile positioning. That is, when typing, the user who has got used to typing senses a gap around an edge of each key and adjusts positions of the fingers, and senses some specified keys (for example, specified keys of J and F) by a protrusion on the specified key and determines a position of the specified key.

Currently, most of touch panel having smooth surfaces use virtual keyboards. Thus, the touch panel cannot provide a tactile feedback, and the user visually performs the positioning of fingers to the virtual keyboard. However, in an actual operation, both the virtual keyboard and the display contents of the touch panel need to be confirmed by the user. This may easily cause wrong input of keys and touch typing is hard to achieve on the touch panel.

### SUMMARY

It is an object of the embodiments of the present disclosure to provide an electronic device providing an actual tactile sensation and a key input prompt method utilized in an electronic device so that the touch panel can provide an actual tactile sensation.

In order to achieve above-described purpose, one embodiment of the present disclosure provides an electronic device. The electronic device includes: a touch panel; a plurality of transparent deformation units arranged above the touch panel, each of the plurality of deformation units corresponding to one area of the touch panel and each of the plurality of deformation units having an initial shape; a first detection unit that detects whether a virtual keyboard is displayed on the touch panel and acquires a first determination result; a first specifying unit that selects at least one target character from a plurality of characters included in the virtual keyboard and specifies a display area of the at least one target character on the touch panel when the first detection result indicates that the virtual keyboard is displayed on the touch panel; a second specifying unit that specifies, from the plurality of deformation units, a target deformation unit that corresponds to the display area; and a generation unit that generates an excitation source for exciting the target deformation unit, the target deformation unit being deformed from the initial shape to a target shape under the control of the excitation source,

Alternatively, the first specifying unit includes: a prompt module that prompts a user to select the at least one target character when the first detection result indicates that the virtual keyboard is displayed on the touch panel; a detection module that detects an operation made by the user via the touch panel, and specifies the at least one target character selected by the user based on the operation made by the user; and a positioning unit that specifies the display area of the at least one target character on the touch panel based on setting information of the virtual keyboard.

Alternatively, the electronic device further includes: a second detection unit that detects whether the display of the virtual keyboard on the touch panel is ended and generates a second determination result when the first determination result indicates that the virtual keyboard is displayed on the touch panel; and a control unit that controls the generation unit to end the generation of the excitation source so that the target deformation unit recovers from the target shape to the initial shape when the second determination result indicates that the display of the virtual keyboard on the touch panel is ended.

Alternatively, each of the plurality of the deformation units includes electrorheological liquid, and the excitation source is an electric current or electric field.

Alternatively, each of the plurality of the deformation units includes magnetorheological liquid, and the excitation source is a magnetic field.

Alternatively, each of the plurality of deformation units includes polymer gel, and the excitation source is capable of generating an excitation to the polymer gel.

Alternatively, each of the plurality of deformation units is a transparent elastic cavity, and the generation unit includes: a storage cavity for storing a gas or liquid, the storage cavity being connected with the transparent elastic cavity via a hollow pipe; a micro motor arranged in a correspondence with the transparent elastic cavity, the micro motor extracting the gas or liquid from the storage cavity and transferring the gas or liquid that is extracted to the transparent elastic cavity; and a control unit that controls an operation of the micro motor.

Alternatively, the plurality of deformation units are arranged uniformly.

In order to achieve above-described purpose, another embodiment of the present disclosure provides a key input prompt method that is utilized in an electronic device. The electronic device includes a touch panel and a plurality of deformation units arranged above the touch panel, each of the plurality of deformation units corresponding to an area on the touch panel and each of the plurality of deformation units having an initial shape, wherein the key input prompt method comprising: detecting whether a virtual keyboard is displayed on the touch panel; selecting at least one target character from a plurality of characters included in the virtual keyboard and specifying a display area of the at least one target character on the touch panel when it is detected that the virtual keyboard is displayed on the touch panel; specifying a target deformation unit that corresponds to the display area from the plurality of deformation units; and generating an excitation source for exciting the target deformation unit, the target deformation unit being deformed from the initial shape to a target shape under the control of the excitation source.

Alternatively, the step of selecting at least one target character from a plurality of characters included in the virtual keyboard and specifying a display area of the at least one target character on the touch panel when it is detected that the virtual keyboard is displayed on the touch panel further comprises: prompting the user to select the at least one target character when it is detected that the virtual keyboard is displayed on the touch panel; detecting an operation made by the user via the touch panel and specifying the at least one target character selected by the user based on the operation made by the user; and specifying the display area of the at least one target character on the touch panel based on setting information of the virtual keyboard.

Alternatively, the key input prompt method further includes: detecting whether the display of the virtual keyboard on the touch panel is ended when it is detected that the virtual keyboard is displayed on the touch panel; and ending the generation of the excitation source so that the target deformation unit recovers from the target shape to the initial shape when it is detected that the display of the virtual keyboard on the touch panel is ended.

The present disclosure provides the following advantages.

In the embodiments of the present disclosure, the deformation units are arranged on a surface of the touch panel. With the deformation units, a shape of one deformation unit that is disposed above the target character is deformed when the virtual keyboard is displayed on the touch panel. Thus, the one deformation unit is distinguishable from other deformation units. Thus, the user is able to specify the character on the virtual keyboard via the deformation, and the user can perform a touch typing without viewing the virtual keyboard. Thus, the present disclosure can provide a convenient key input performance to the user, and can improve a key input efficiency when the user performs key input using the virtual keyboard.

### BRIEF DESCRIPTION OF THE DRAWINGS

FIG. 1 is a diagram showing a configuration of an electronic device according to the present disclosure;

FIG. 2 is a diagram showing an arrangement of a deformation unit and a touch panel according to the present disclosure;

FIG. 3 is a diagram showing an embodiment in which the electronic device is a mobile phone; and

FIG. 4 is a diagram showing steps of a key input prompt method according to the present disclosure.

### DETAILED DESCRIPTION

To make the objects, the technical solutions and the advantages of the present disclosure more apparent, the following will describe the present disclosure with reference to specific embodiments and accompanying drawings.

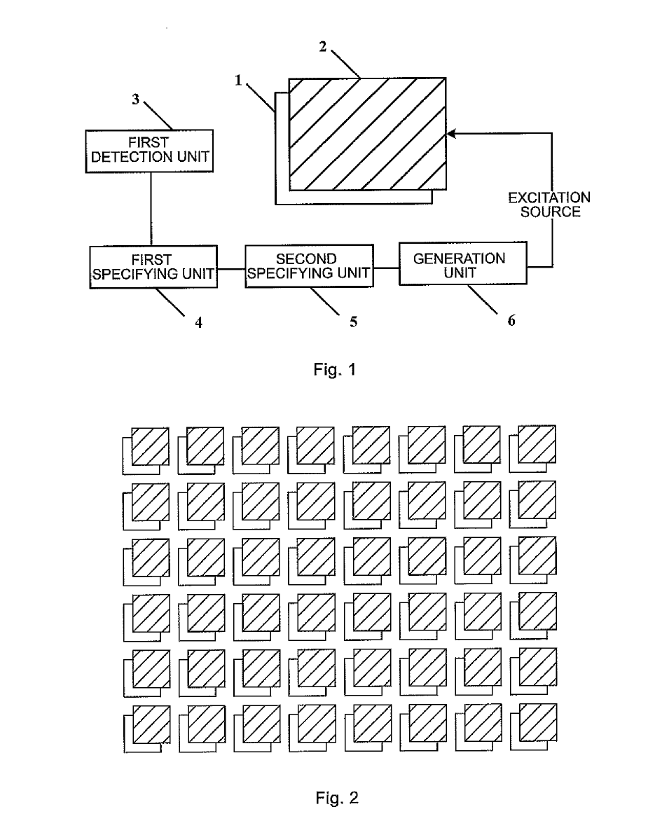

FIG. 1 shows an electronic device provided by the present disclosure. The electronic device includes:

a touch panel 1 (a lower side block in FIG. 1);

multiple transparent deformation units 2 (an upper side block with hatching lines in FIG. 1, the block indicates a group of multiple deformation units 2) positioned on the touch panel, each deformation unit corresponds to one area of the touch panel and each deformation unit has an initial shape;

a first detection unit 3 that detects whether a virtual keyboard is displayed on the touch panel and acquires a first determination result;

a first specifying unit 4 that selects at least one target character from multiple characters included in the virtual keyboard and specifies a display area of the target character on the touch panel when the first detection result indicates that the virtual keyboard is displayed on the touch panel;

a second specifying unit 5 that specifies, from multiple deformation units, a target deformation unit that corresponds to the display area; and

a generation unit 6 that generates an excitation source for exciting the target deformation unit, the target deformation unit deforms from the initial shape to a target shape under the control of the excitation source.

In the specific embodiment of the present disclosure, the deformation units are arranged on a surface of the touch panel. With the deformation units, a shape of one deformation unit that is disposed above the target character is deformed when the virtual keyboard is displayed on the touch panel. Thus, the one deformation unit is distinguishable from other deformation units. Thus, the user is able to specify the character on the virtual keyboard via the deformation, and the user can perform a touch typing without viewing the virtual keyboard. Thus, the present disclosure can provide a convenient key input performance to the user, and can improve a key input efficiency when the user performs key input using the virtual keyboard.

In the specific embodiment of the present disclosure, the target character needs to be set in order to provide, to the user, a convenient positioning of a character on the virtual keyboard. The target character may be set by a preliminary setting manner or a user selection manner as the following.

### Preliminary Setting

In the preliminary setting manner, the electronic device preliminarily stores the target character corresponding to each kind of virtual keyboard. After the virtual keyboard is displayed on the touch panel, a target character corresponding to a current virtual keyboard can be specified based on the preliminarily stored target character of each kind of virtual keyboard. Then, the target deformation unit of the display area, which corresponds to the target character, is deformed to the target shape.

Of course, in order to provide a better tactile sensation to the user, the preliminarily stored target character should reflect a use habit of the user. The following will describe a specific example.

For example, a full-sized virtual keyboard has a character arrangement approximately similar to an arrangement of actual keyboard of a personal computer. Considering the common use habit of the users, the character “F” and the character “J” can be set as the target character. That is, deformation unit corresponding to a part or an entire display area of the character “F” or the character “J” deforms from the initial shape to the target shape (the target shape provides a tactile sensation to the user). When the user performs touch typing, the user can determine positions of other characters on the touch panel after sensing the deformed character “F” and the deformed character “J” in tactile manner.

For another example, a virtual keyboard in which characters are arranged in grid manner, the character “5” can be set as the target character, and is preliminarily stored.

### User Selection

Of course, each user may have a different use habit. Thus, sometimes, the preliminary setting manner cannot satisfy different use habits of all of the users. For example, some user needs many specified characters to determine positions of all of the characters when using the full-sized virtual keyboard (only setting the character “F” and the character “F” cannot satisfy a positioning requirement of the user), or some user may get used to set different characters as a positioning reference.

With consideration of above-described case, the embodiment of the present disclosure enables a selection of the target character by the user.

In this manner, the first specifying unit includes:

a prompt module that prompts a user to select the target character when the first detection result indicates that the virtual keyboard is displayed on the touch panel;

a detection module that detects, via the touch panel, an operation made by the user and specifies the target character selected by the user based on the operation made by the user; and

a positioning unit that specifies the display area of the target character on the touch panel based on setting information of the virtual keyboard.

As described above, when the electronic device actively sets the target character, a positioning requirement of the user can be satisfied and an operation by the user can be simplified. Further, when the electronic device passively sets the target character, a customized positioning requirement corresponding to each user can be satisfied, and can provide an improved use performance.

Furthermore, in order to not affect other follow-up operations of the user, when the display of the virtual keyboard on the touch panel is ended, the deformation unit that has been deformed needs to be recovered to the initial shape. Thus, the electronic device according to the present disclosure further includes:

a second detection unit that detects whether the display of the virtual keyboard on the touch panel is ended and generates a second determination result when the first determination result indicates that the virtual keyboard is displayed on the touch panel; and

a control unit that controls the generation unit to end the generation of the excitation source so that the target deformation unit recovers from the target shape to the initial shape when the second determination result indicates that the display of the virtual keyboard on the touch panel is ended.

The following will describe the generation unit and the deformation unit of the above-described electronic device in detail.

In the following detailed description of the above embodiment, suppose that the electronic device is a mobile phone. As shown in FIG. 2, the touch panel includes multiple pixels, and each pixel is defined as one base area (the block with hatching lines). Alternatively, multiple pixels can be defined as one base area. In the following description, detailed description for each embodiment will be omitted.

### First Implementation

In the first implementation, the deformation unit includes electrorheological fluid, and the excitation source generated by the generation unit is an electric current or electric field (in the following description, electric current will be described as an example).

The electrorheological fluid has 50 years of development history. The electrorheological fluid deforms under an electric current control.

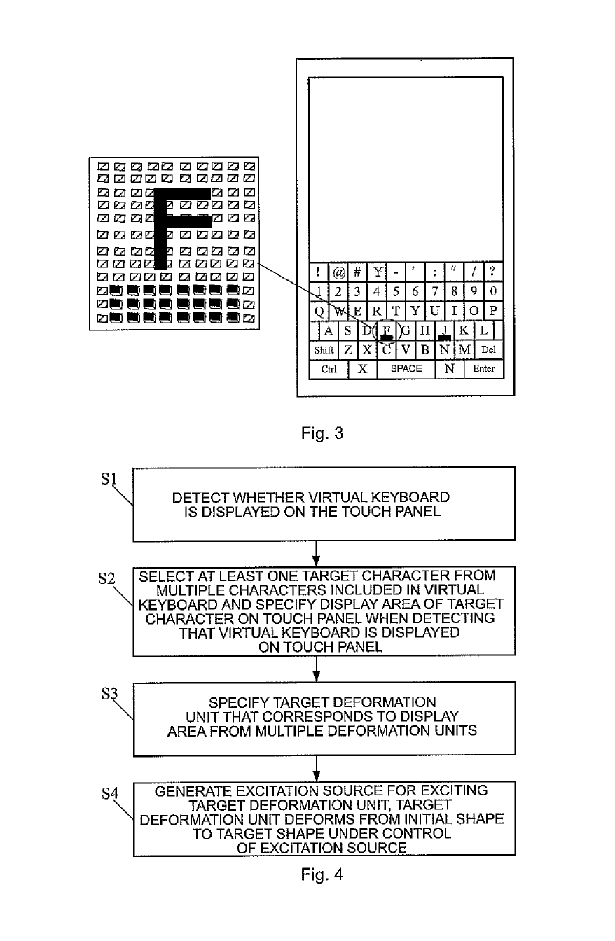

Suppose that the user selects an editing of a text message by touching as shown in FIG. 3, the touch panel of the mobile phone displays an editing text message and a full-sized virtual keyboard. In this case, the character “F” and the character “J” are set as the target characters. With the character “F” as an example, suppose that the character “F” is displayed on a block of display area having 60 pixels×60 pixels, and the 3600 pixels correspond to 3600 electrorheological fluid of the deformation unit (the deformation unit of the display area is the target deformation unit in the present description, of course, this is only one example, further, one deformation unit corresponds to multiple pixels, for example, one deformation unit corresponds to 25 pixels).

The generation unit is electrically connected with the deformation unit that includes the electrorheological fluid, and generates electric signals and transmits the electric signals to the deformation unit including 3600 units of electrorheological fluid. The deformation unit including multiple units of electrorheological fluid deforms under the control of the excitation source (electric current). A protrusion is formed on a surface of the deformation unit, under a predetermined limitation (for example, controlling a deformation direction using an elastic film).

When the user performs the typing, the user can see the character “F” with his or her eyes. Further, the deformed deformation unit which includes multiple units of electrorheological fluid is different from other deformation units having the initial shapes. Thus, the user can sense the key by tactile sensation. That is, it is possible to provide an actual tactile sensation to the user. When the user performs the typing, a pressure applied by the finger is transferred to the touch panel via the deformation unit so that touch control can be achieved.

In the above description, the deformation unit included in the display area generates a height deformation so that the user can sense the key in tactile manner. In order to provide an improved performance to the user, the generation unit can selectively provide the electric signal to the predetermined deformation units in the display area. Under multiple electric current control, the deformation unit including 3600 units of electrorheological fluid can form any one target shape together with one another. For example, the character “F” shown in FIG. 3 corresponds to a rectangular protrusion (multiple black full blocks).

### Second Implementation

Similarly, with the character “F” shown in FIG. 3 as an example, suppose that the character “F” is displayed on a block of display area having 60 pixels×60 pixels. In the second implementation, the deformation unit includes magnetorheological fluid, and the excitation source generated by the generation unit is a magnetic field.

The generation unit generates a magnetic field in an area corresponding to the deformation unit including 3600 units of the magnetorheological fluid. The deformation unit including the magnetorheological fluid deforms under the control of the excitation source (magnetic field), and a protrusion is formed on a surface of the deformation unit.

When the user performs the typing, the user can see the character “F” with his or her eyes. Meanwhile, when the user clicks the touch panel, the deformation unit ,configured by electrorheological fluid, of a display area corresponding to the key is higher than other deformation units having the initial shapes. Thus, the user can sense the key by tactile sensation. That is, it is possible to provide an actual tactile sensation to the user. When the user performs the typing, a pressure applied by the finger is transferred to the touch panel via the deformation unit so that touch control can be achieved.

In the above description, in order to provide an improved performance to the user, the generation unit can generate a magnetic field having a predetermined intensity distribution in the area corresponding to the deformation unit including 3600 units of magnetorheological fluid. Under the magnetic field having the predetermined intensity distribution, the 3600 units of magnetorheological fluid can form any one target shape together with one another. For example, the character “F” shown in FIG. 3 corresponds to a rectangular protrusion.

### Third Implementation

Similarly, with the character “F” shown in FIG. 3 as an example, suppose that the character “F” is displayed on a block of display area having 60 pixels×60 pixels. In the third implementation, the deformation unit includes polymer gel, and the excitation source generated by the generation unit may be an electric field, a temperature, or an illumination of light.

Gel state is a material state between a liquid state and solid state. The polymer gel has a three-dimensional-cross-linked network structure. The network includes hydrophilic (polarized) groups and hydrophobic groups or (and) dissociation groups positioned in a macromolecular backbone chain and side chains, the solvent is fixed in the molecule network.

A typical excitation source that can generate excitation to the polymer gel includes a temperature, pH value, solvent, salt concentration, light, electric field, and chemical material. When the polymer gel receives the external excitation, a discontinuous change occurs in volume of the polymer gel.

When the pH value, ionic strength, temperature, electric field of external environment and the chemical material contained in the environment changes, the polymer gel shows a “stimulus-response” status. For example, when a phase transition occurs in the polymer gel, the distance between meshed network increases, and the network loses an elasticity, and the volume of the network rapidly change (may vary as much as several hundred times). These changes are reversible and discontinuous.

Suppose that the 3600 pixels correspond to the 3600 units of polymer gel that configure the deformation unit.

When the electric current is used as the excitation source, the generation unit is electrically connected with each of the deformation unit that includes the polymer gel, and generates an electric signal and transmits the electric signal to the deformation unit including 3600 units of polymer gel. The deformation unit including multiple units of polymer gel deforms under the control of the excitation source (electric current), and a protrusion is formed on a surface of the deformation unit.

When the user performs the typing, the user can see the character “F” with his or her eyes. Meanwhile, when the user clicks the touch panel, the deformation unit ,configured by polymer gel, of a display area corresponding to the key is higher than other deformation units having the initial shapes. Thus, the user can sense the key by tactile sensation. When the user performs the typing, a pressure applied by the finger is transferred to the touch panel via the deformation unit so that touch control can be achieved.

In the above description, a height of the deformation unit corresponding to the key displayed by a display apparatus is changed so that the user can sense the key. In order to further improve a use performance, the generation unit may generate multiple electric signals, and selectively control the deformation unit configured by the polymer gel in the display area to deform properly so that the deformation unit configured by the 3600 units of polymer gel can form any one target shape together with one another under the multiple electric signals. For example, the character “F” shown in FIG. 3 corresponds to a rectangular protrusion.

Of course, other type of energy can be used as the excitation source, such as, illumination of light. When the generation unit generates lights having different strengths and transfers the lights to the deformation unit configured by the polymer gel via an optical fiber or via a light guide pipe, a protrusion is formed on a surface of the deformation unit.

### Fourth Implementation

In the above-described first implementation to the third implementation, the deformation unit is made of different materials, and the material deforms under an external energy (electric, magnetic, light or the like), and a protrusion is formed on the surface of the deformation unit. In the fourth implementation, a micro mechanic structure is used for the deformation.

In the fourth implementation, the deformation unit is a transparent elastic cavity, and the transparent elastic cavity is expandable by charging gas or charging liquid. The generation unit includes:

a storage cavity for storing a gas or liquid, the storage cavity is connected with the transparent elastic cavity via a hollow pipe;

a micro motor disposed corresponding to the transparent elastic cavity, the micro motor extracts the gas or liquid from the storage cavity and transfers the gas or liquid that is extracted to the transparent elastic cavity; and

a control unit that controls an operation of the micro motor.

Similarly, with the character “F” shown in FIG. 3 as an example, suppose that the character “F” is displayed on a block of display area having 60 pixels×60 pixels. The 3600 pixels in the display area correspond to the 3600 transparent elastic cavities that configure the deformation unit.

The storage cavity that stores the gas or the liquid is connected with the deformation unit configured by the transparent elastic cavities via the hollow pipe. The micro motor, under the control of the control unit, extracts the gas or liquid, and transfers the gas or the liquid that is extracted to the transparent elastic cavity so that the cavity is expanded and a protrusion is formed on a surface of the transparent elastic cavity.

When the user performs the typing, the user can see the character “F” with his or her eyes. Meanwhile, when the user clicks the touch panel, the transparent elastic cavities in the area corresponding to the character “F” are higher than other transparent elastic cavities in other area. Thus, the user can sense the key by tactile sensation. When the user performs the typing, a pressure applied by the finger is transferred to the touch panel via the deformation unit so that touch control can be achieved.

In the above description, in order to further improve a use performance, the control unit can accurately control each micro motor, and selectively transfers the gas or liquid to the transparent elastic cavities included in the display area so that the 3600 transparent elastic cavities form any target shape together with one another. For example, the character “F” shown in FIG. 3 corresponds to a rectangular protrusion.

In the above-described four kinds of implementations, the deformation unit can acquire an accurate shape distribution or a time axis distribution by accurately controlling a distribution time and area of the excitation source. Preferably, each deformation unit has a predetermined height after the deformation. A recovery of the deformation unit to the initial shape is different in material and excitation. Thus, detailed description will be omitted.

In the above description, the deformation units are arranged at the same intervals (uniformly). Further, the deformation units can be arranged according to actual needs and can be arranged at different intervals. In the above description, when referring to display, the deformation unit transmits the lights so that an image to be displayed is not blocked by the deformation unit.

Of course, the electronic device according to the present disclosure is not limited to the mobile phone. The electronic device may be a tablet computer, an ATM or the like. The following will describe advantages provided by an example in which the electronic device is ATM.

Current ATM device usually includes a touch panel, and the touch panel displays an operation system menu. The operation system menu corresponds to the virtual keyboard according to the present disclosure. As easily known, the deformation unit can form specific braille by an accurate control of the excitation source. Thus, a blind person can also operate the ATM device to use ATM services. Thus, the electronic device according to the present disclosure plays an important role in the human development.

It should be understood that, in the embodiments of the present disclosure, the target shape may be formed by various types. The following will describe a formation of the target shape with the character “F” shown in FIG. 3 as an example.

For example, controlling one or multiple deformation units included in the area corresponding to “F” to protrude by the same height so that multiple protrusion structure is formed.

For another example, controlling the deformation units included in the area corresponding to “F” to protrude by the same height so that protruded trapezoid structure is formed.

For another example, controlling the deformation units included in a partial area in which the character “F” is displayed to protrude by the same height. That is, in FIG. 2, the deformation units corresponding to black bold “F” are protruded by the same heights and deformation units positioned other than the rectangular area including the character “F” maintain the same so that protruded “F” is formed.

For another example, in the rectangular area including the character “F”, the part that does not display the black bold “F” protrude by the same height so that a recessed character “F” is formed.

Further, the target shape can be formed by other different methods, and the methods are not described in detail herein.

In the embodiment of the present disclosure, the shape of the deformation unit can have various shapes, and is not limited to the shape shown in the drawings. For example, the deformation unit can have a ring shape, a circular shape, or a triangular shape.

Of course, when the current virtual keyboard changes to another virtual keyboard, the position of the target character needs to be newly specified, and the deformation unit to be deformed need to be newly specified, and a control is carried out correspondingly.

Further, as shown in FIG. 4, a key input prompt method is utilized in an electronic device, which includes a touch panel and multiple deformation units arranged above the touch panel. Each of the multiple deformation units corresponds to an area on the touch panel and each of the multiple deformation units has an initial shape. The key input prompt method includes:

a step S1, detecting whether a virtual keyboard is displayed on the touch panel;

a step S2, selecting at least one target character from multiple characters included in the virtual keyboard when it is detected that the virtual keyboard is displayed on the touch panel, and specifying a display area of the target character on the touch panel;

a step S3, specifying, from multiple deformation units, a target deformation unit that corresponds to the display area; and

a step S4, generating an excitation source for exciting the target deformation unit, the target deformation unit being deformed from the initial shape to a target shape under the control of the excitation source.

In the key input prompt method according to the present embodiment, the deformation units are set and the shapes of the deformation units are controlled in order that the touch panel can provide an actual tactile sensation to the user. With this method, the user can quickly determine the positions of the keys on the touch panel.

In order to satisfy use habits of all of the users, the user can actively set the target character of the virtual keyboard. That is, the step S2 includes:

a step S21, prompting the user to select the target character when it is detected that the virtual keyboard is displayed on the touch panel;

a step S22, detecting, via the touch panel, an operation made by the user and specifying the target character selected by the user based on the operation made by the user; and

a step S23, specifying the display area of the target character on the touch panel based on setting information of the virtual keyboard.

The above-described deformation of the deformation unit is reversible. That is, the key input prompt method further includes:

a step S5, detecting whether the display of the virtual keyboard on the touch panel is ended when it is detected that the virtual keyboard is displayed on the touch panel; and

a step S6, ending the generation of the excitation source so that the target deformation unit recovers from the target shape to the initial shape when it is detected that the display of the virtual keyboard on the touch panel is ended.

The following will describe specific implementation of the step S5 and the step S6 in detail.

Suppose that the electronic device according to the present disclosure is a mobile phone, based on an operation command made by the user, the display of the virtual keyboard on the touch panel can be detected. When the user clicks a text edit menu on the touch panel, the operation command of generating the virtual keyboard is automatically generated. Thus, based on this operation command, the display of the virtual keyboard on the touch panel can be detected. When it is determined that the virtual keyboard is displayed, an ending of the display of the virtual keyboard can be determined based on an exit operation command from the text editing, such as an exit, back and main menu. Accordingly, the generation of the excitation source is ended so that the target deformation unit can recover from the target shape to the initial shape.

Obviously, above-described key input prompt method corresponds to the electronic device according to the present disclosure, and the method also provides advantages similar to the advantages provided by the electronic device.

Obviously, those skilled in the art can change and modify present disclosure in various ways without departing from a spirit and a scope of the present disclosure. Thus, when the change and modification of the present disclosure belong to a scope of the claims of the present disclosure and their equivalents, the present disclosure also intends to include these changes and modifications.

What is claimed is:

1. An electronic device comprising:
a touch panel;
a plurality of transparent deformation units arranged above the touch panel, each of the plurality of deformation units corresponding to one area of the touch panel and each of the plurality of deformation units having an initial shape;
a first detection unit that detects whether a virtual keyboard is displayed on the touch panel and acquires a first determination result;
a first specifying unit that selects at least one target character from a plurality of characters included in the virtual keyboard and specifies a display area of the at least one target character on the touch panel when the first detection result indicates that the virtual keyboard is displayed on the touch panel;
a second specifying unit that specifies, from the plurality of deformation units, a target deformation unit that corresponds to the display area; and
a generation unit that generates an excitation source for exciting the target deformation unit, the target deformation unit being deformed from the initial shape to a target shape under the control of the excitation source.

2. The electronic device according to claim 1, wherein
the first specifying unit includes:
a prompt module that prompts a user to select the at least one target character when the first detection result indicates that the virtual keyboard is displayed on the touch panel;
a detection module that detects an operation made by the user via the touch panel, and specifies the at least one target character selected by the user based on the operation made by the user; and
a positioning unit that specifies the display area of the at least one target character on the touch panel based on setting information of the virtual keyboard.

3. The electronic device according to claim 1, further comprising:
a second detection unit that detects whether the display of the virtual keyboard on the touch panel is ended and generates a second determination result when the first determination result indicates that the virtual keyboard is displayed on the touch panel; and
a control unit that controls the generation unit to end the generation of the excitation source so that the target deformation unit recovers from the target shape to the initial shape when the second determination result indicates that the display of the virtual keyboard on the touch panel is ended.

4. The electronic device according to claim 1, wherein
each of the plurality of the deformation units includes electrorheological liquid, and the excitation source is an electric current or electric field.

5. The electronic device according to claim 1, wherein
each of the plurality of the deformation units includes magnetorheological liquid, and the excitation source is a magnetic field.

6. The electronic device according to claim 1, wherein
each of the plurality of deformation units includes polymer gel, and the excitation source is capable of generating an excitation to the polymer gel.

7. The electronic device according to claim 1, wherein
each of the plurality of deformation units is a transparent elastic cavity, and
the generation unit includes:
a storage cavity for storing a gas or liquid, the storage cavity being connected with the transparent elastic cavity via a hollow pipe;
a micro motor arranged in a correspondence with the transparent elastic cavity, the micro motor extracting the gas or liquid from the storage cavity and transferring the gas or liquid that is extracted to the transparent elastic cavity; and
a control unit that controls an operation of the micro motor.

8. The electronic device according to any one of claims 1 to 7, wherein
the plurality of deformation units is arranged uniformly.

9. A key input prompt method utilized in an electronic device, wherein the electronic device comprising a touch panel and a plurality of deformation units arranged above the touch panel, each of the plurality of deformation units corresponding to an area on the touch panel and each of the plurality of deformation units having an initial shape,
wherein the key input prompt method comprises:
detecting whether a virtual keyboard is displayed on the touch panel;
selecting at least one target character from a plurality of characters included in the virtual keyboard and specifying a display area of the at least one target character on the touch panel when it is detected that the virtual keyboard is displayed on the touch panel;
specifying a target deformation unit that corresponds to the display area from the plurality of deformation units; and
generating an excitation source for exciting the target deformation unit, the target deformation unit being deformed from the initial shape to a target shape under the control of the excitation source.

10. The key input prompt method according to claim 9, wherein the step of selecting at least one target character from a plurality of characters included in the virtual keyboard and specifying a display area of the at least one target character on the touch panel when it is detected that the virtual keyboard is displayed on the touch panel further comprises:
prompting the user to select the at least one target character when it is detected that the virtual keyboard is displayed on the touch panel;
detecting an operation made by the user via the touch panel and specifying the at least one target character selected by the user based on the operation made by the user; and
specifying the display area of the at least one target character on the touch panel based on setting information of the virtual keyboard.

11. The key input prompt method according to claim 10, further comprising:
detecting whether the display of the virtual keyboard on the touch panel is ended when it is detected that the virtual keyboard is displayed on the touch panel; and
ending the generation of the excitation source so that the target deformation unit recovers from the target shape to the initial shape when it is detected that the display of the virtual keyboard on the touch panel is ended.
